(19) United States
(12) Patent Application Publication
(10) Pub. No.: US 2026/0243170 A1
(43) Pub. Date: Aug. 20, 2026

(54) AN ARC REACTION ENGINE AND METHOD OF USE

(71) Applicant: ACE VTOL PTY LTD, Perth, Western Australia (AU)

(72) Inventor: Brett NORTHEY, Perth, Western Australia (AU)

(73) Assignee: ACE VTOL PTY LTD, Perth, Western Australia (AU)

(21) Appl. No.: 19/470,944

(22) PCT Filed: Apr. 2, 2024
(86) PCT No.: PCT/AU2024/050310

§ 371 Date: Sep. 30, 2025

(30) Foreign Application Priority Data
Mar. 31, 2023 (AU) 2023900919

(51) Int. Cl. F01D 15/00; F01D 5/06; F03H 1/00; H05H 1/34

(52) U.S. Cl. CPC F01D 15/00; F01D 5/06; F03H 1/00; H05H 1/3478

(57) ABSTRACT

A reaction engine for producing thrust with respect to an intake fluid, wherein the fluid is configured to move from an intake end to an exhaust end of the reaction engine along an enclosed airflow path, the reaction engine including: a thrust generating assembly for generating acceleration of the fluid moving within a first airflow path portion of the airflow path; and an airflow heating arrangement including an electrical heating means configured to cause a temperature increase of the fluid within a second airflow path portion of the airflow, such that the heated fluid exits the reaction engine at the exhaust end to thereby provide thrust.

### FIELD OF THE INVENTION

The invention generally relates to a reaction engine and method of use of a reaction engine.

### BACKGROUND TO THE INVENTION

Conventional aerospace reaction engines, such as jet engines and variations such as turbojets and the like are known to utilise chemical energy. However, recent developments in propulsion technologies have considered electrically powered reaction engines. A problem that exists with electrically powered aircraft engines is the need to store sufficient electrical energy to allow for the aircraft to operate over useful distances, accounting for the weight added by such storage. Additionally, a problem exists with obtaining sufficient thrust from the engines to achieve stable flight. It would therefore be desirable to provide one or more novel developments in reaction to electrically powered reaction engines.

### SUMMARY OF THE INVENTION

According to an aspect of the present disclosure, there is provided a reaction engine for producing thrust with respect to an intake fluid, wherein the fluid is configured to move from an intake end to an exhaust end of the reaction engine along an enclosed airflow path, the reaction engine comprising: a thrust generating assembly for generating acceleration of the fluid moving within a first airflow path portion of the airflow path; and an airflow heating arrangement comprising an electrical heating means configured to cause a temperature increase of the fluid within a second airflow path portion of the airflow, such that the heated fluid exits the reaction engine at the exhaust end to thereby provide thrust.

Optionally, the thrust generating assembly has an input end for receiving fluid and wherein the fluid exits the thrust generating assembly at an output end, and wherein the thrust generating assembly encompasses the first airflow portion of the airflow path. The thrust generating assembly may comprise a mechanical thrust generator for generating acceleration of the fluid within an active region of the first airflow path portion, and the first airflow path portion may comprise a free region separate to the active region, and the thrust generating assembly may be configured to cause inductive airflow within the free region due to airflow within the active region. The mechanical thrust generator may comprise a rotor assembly comprising one or more rotor stages, and each rotor stage may comprise: a ring-shaped rotor having an internal volume encompassing at least part of the first airflow path portion and defining a central axis about which the rotor rotates, and the rotor may be controllably driven for generating acceleration of the fluid; and an arrangement of blades about an inner circumference of the rotor, each blade extending inwards from the rotor by a distance smaller than a radius of the rotor, and the active region may correspond to the volume of the first airflow path portion through which the arrangement of blades moves during rotation of the rotor, and the arrangement of blades may thereby be configured to cause acceleration of the fluid within the active region, and the free region may correspond, in substance, to the remaining volume of the first airflow path portion.

In an embodiment, the rotor assembly may be arranged to generate inductive airflow within the free region due to the fluid acceleration within the active region of the one or more rotor stages. The reaction engine may comprising two or more rotor stages arranged in sequence such that one rotor stage is an input rotor stage located proximal the intake end of the reaction engine and one rotor stage is an output rotor stage located proximal the exhaust end of the reaction engine, and wherein the first airflow path portion corresponds to the combined internal volumes of the two or more rotor stages. Each rotor stage may be associated with a rotation direction corresponding to the direction in which its rotor is configured for rotation in order to cause acceleration of the fluid towards the exhaust end, and for each rotor stage said rotation direction is selected from either a first direction or an opposite second direction, and the rotor stages may be arranged in a sequence of alternating rotation directions. The blades of each rotor stage may be configured such that an interaction between adjacent rotor stages is such as to generate opposing vortices directed towards the central axes of the rotor stages. Each blade may have a structure configured to induce vortices due to a difference in fluid flowrate from a root of the blade to a tip of the blade between a lower surface of the blade and an upper surface of the blade. Each blade may have a variable blade angle that changes between the blade root and the blade tip, with a distributed pitch profile of around 45 degrees. The output rotor stage may have a smaller free region than that of the input rotor stage. The rotor of the output rotor stage may have a smaller inner circumference than that of the rotor of the input rotor stage.

In an embodiment, the, or each, rotor stage may comprise a support frame, and the rotor of the, or each, rotor stage may be rotatably mounted to the support frame of the particular rotor stage. At least one support frame may comprise an annular support frame bearing structure and the corresponding rotor may comprise a complementary annular rotor bearing structure, and the rotor may be rotatably mounted to its corresponding support frame via an interface between the complementary support frame bearing structure and rotor bearing structure. At least one support frame may comprise a support frame bearing structure comprising one or more bearing races and a rotor bearing structure comprising a corresponding one or more roller bearings. The, or each, support frame bearing structure and complementary rotor bearing structure may be electrically conductive and provide an electrical connect between the corresponding support frame and rotor. At least one support frame bearing structure may be formed, at least in part, from an electrically conductive beryllium copper alloy. At least one rotor bearing structure may be formed, at least in part, from an electrically conductive beryllium copper alloy.

In an embodiment, at least one rotor may be driven by a controllable electromotive force. The at least one rotor may comprise an arrangement of magnets proximal to an outside circumference of the rotor, and its corresponding support frame may comprise an arrangement of one or more accelerator units configured to generate the electromotive force. The magnets may be arranged with substantially aligned polarities. The reaction engine may comprise, for at least one rotor stage, a plurality of accelerator units arranged at substantially equal spacing around an inside circumference of the corresponding support frame, and the accelerator units may be configured to produce an electromagnetic force due to a received AC electrical power supply. A rotation rate of the, or each, rotor may be controllable, at least in part, by control of a frequency of the received AC electrical power supply. The reaction engine may further comprise a battery electrically coupled to an alternating current generator configured to generate the AC electrical power supply based on a DC battery power supply, and the alternating current generator is controllable such as to control at least one parameter of the generated AC electrical power supply. The at least one parameter may include an alternating current frequency. The accelerator units are preferably removeable.

Optionally, the airflow heating arrangement comprises plasma arcing means for generating a plasma arc within at least a portion of the second airflow path to thereby cause temperature increase of the fluid within a second airflow path portion. The plasma arcing means may comprise a first electrode and a second electrode, and the first electrode may be located spaced apart from the second electrode such as to generate an electrical potential difference within the second airflow path. One or more blades of at least one rotor stage may be electrically conductive and the first electrode may therefore correspond to the combined arrangement of the one or more electrically conductive blades. Each of the one or more electrically conductive blades may comprise an electrical connector at its root being electrically coupled to a rotor contact of its corresponding rotor stage configured to provide an electrical contact at an outside circumference of the rotor of the rotor stage. The second electrode may be located substantially proximal the exhaust end of the reaction engine.

In an embodiment, the reaction engine may comprise a nozzle assembly located and configured to receive fluid flow from the rotor assembly, wherein the fluid exits the reaction engine from the nozzle assembly, and wherein the nozzle assembly comprises conductive structure corresponding to the second electrode. The second electrode may comprise a conductive ring to provide a contact point for the plasma arc, and the nozzle assembly may comprise the conductive ring. The nozzle assembly may have an internal profile for causing a nozzle effect on the airflow exiting the reaction engine, such that the internal profile cause acceleration of the fluid. The nozzle assembly may comprising a solenoid formed by a conductive wire wound around a core, and the solenoid may define an internal solenoid volume bounded by the core through which at least a part of the second airflow path portion is located, and the solenoid may be arranged to generate a magnetic field within the second airflow path portion when an electric current is present within the wire, and the first electrode and second electrode may be separated by the solenoid internal volume such that the plasma arc extends through said solenoid internal volume. The solenoid may be electrically coupled to the second electrode. The nozzle assembly may be controllably rotatable with respect to the rotor assembly to provide a vectored thrust, and the nozzle assembly may comprise a body defining an internal cavity, and the solenoid may be located within the internal cavity such that the solenoid is rotated with the nozzle assembly.

In an embodiment, the plasma arcing means comprises a high voltage DC power supply configured to generate a sufficient direct current potential difference for generating the plasma arc during operation of the reaction engine. The high voltage DC power supply may be electrically coupled to the first electrode and the second electrode. The high voltage DC power supply may comprise one or more DC induction scavenging units (ISU) arranged on one or more support structures, and each DC ISU may comprise an ISU coil positioned such that the arrangement of magnets of the corresponding rotor move in proximity past the ISU coil to thereby generate an electromotive force within the ISU coil, and each DC ISU may comprise an ISU output circuit for generating an output DC voltage forming at least a portion of the high voltage DC power supply.

Optionally, the reaction engine further comprises a water injection assembly configured to inject water into the airflow.

According to another aspect of the present disclosure, there is provided a method for operating a reaction engine for producing thrust with respect to an intake fluid, wherein the fluid is configured to move from an intake end to an exhaust end of the reaction engine along an enclosed airflow path, the method comprising: generating acceleration of the fluid moving within a first airflow path portion of the airflow path; and causing a temperature increase of the fluid within a second airflow path portion of the airflow, such that the heated fluid exits the reaction engine at the exhaust end to thereby provide thrust.

As used herein, the word “comprise” or variations such as “comprises” or “comprising” is used in an inclusive sense, i.e. to specify the presence of the stated features but not to preclude the presence or addition of further features in various embodiments of the invention.

### BRIEF DESCRIPTION OF THE DRAWINGS

In order that the invention may be more clearly understood, embodiments will now be described, by way of example, with reference to the accompanying drawings, in which:

FIGS. 1A-1B show a propulsion engine according to an embodiment;

FIG. 2 shows multiple rotor stages of a rotor assembly according to an embodiment;

FIGS. 3A-3C show a particular rotor according to an embodiment;

FIGS. 4A-4E show an electromagnetic accelerator unit and the positioning of plural accelerator units on a fixed frame according to an embodiment;

FIGS. 5A-5B show a DC induction scavenge unit (ISU) and the positioning of plural accelerator units on a fixed frame according to an embodiment;

FIGS. 6A and 6B show a rotor blade according to an embodiment;

FIG. 7 shows a support frame for coupling to the rotor assembly according to an embodiment;

FIGS. 8A-8B show a nozzle assembly and its relationship to the support frame according to an embodiment;

FIG. 9A shows an external body and other elements of the engine according to embodiments;

FIG. 9B shows an example position of a conduction heating system according to an embodiment;

FIG. 10 shows a representation of the electrical power system of the engine according to an embodiment;

FIG. 11 shows a solenoid assembly of the nozzle assembly according to an embodiment;

FIG. 12 shows the positioning of magnetrons according to an embodiment; and

FIG. 13 shows an embodiment comprising a water injection assembly.

### DESCRIPTION OF EMBODIMENTS

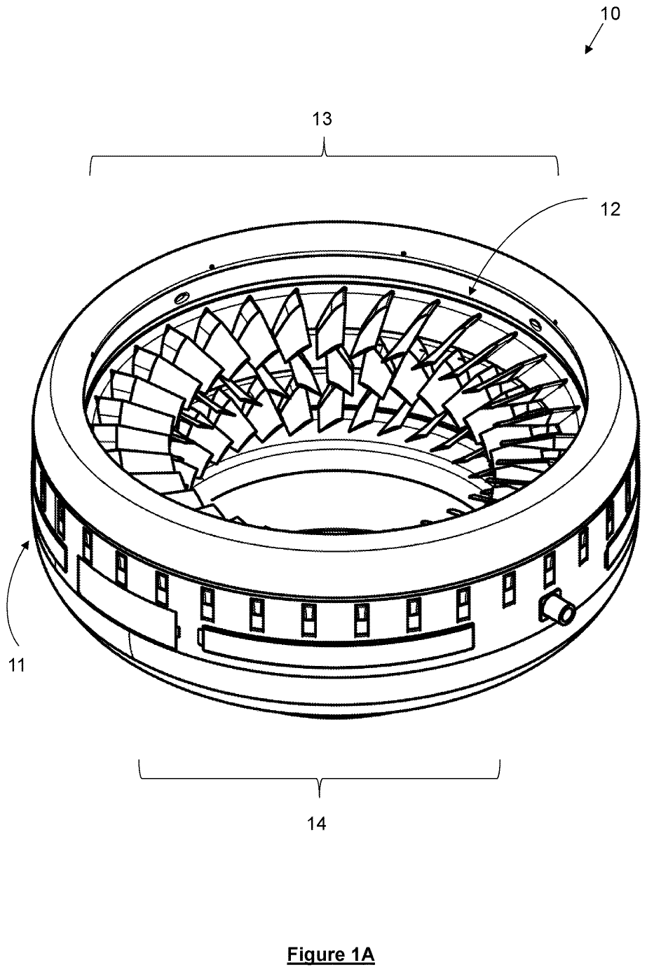

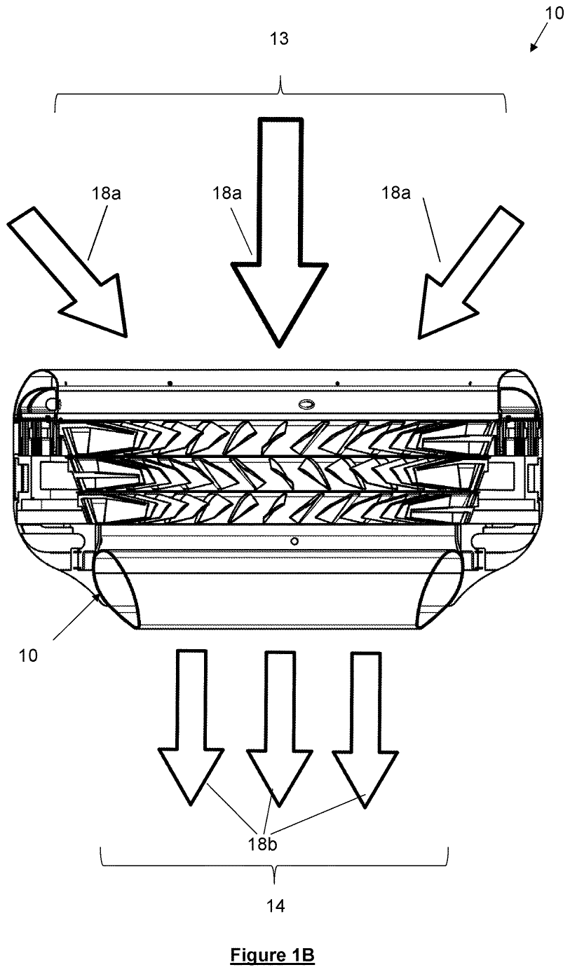

FIGS. 1A and 1B show a propulsion engine 10 according to an embodiment. The engine 10 comprises a body 11 in which a rotor assembly 12 is mounted. The engine 10 has an intake end 13 and an exhaust end 14. The engine 10 is arranged to produce thrust by generating movement of a fluid from the intake end 13 via a flow path towards and out of the exhaust end 14. In FIG. 1B, the flow path is indicated by arrows 18a (fluid flow into the engine 10) and 18b (fluid flow out of the engine 10—i.e. exhaust). For the purposes of the present disclosure, the fluid is assumed to be air (i.e. atmospheric gas) and the terms are used interchangeably unless otherwise stated. Thus, the engine 10 receives air at the intake end 13 and expels it, for example as a jet, from the exhaust end 14. The flow path 18 defines a volume in which the fluid flows that is enclosed by the engine 10.

Referring to FIG. 2, in an embodiment, the rotor assembly 12 comprises two or more rotor stages 20. In the embodiment shown, the rotor assembly 12 comprises three rotor stages 20a-20c. As shown, first rotor stage 20a is located adjacent the intake end 13 and the third rotor stage 20c is located adjacent the exhaust end 14. The second rotor stage 20b is located between the first rotor stage 20a and the third rotor stage 20c.

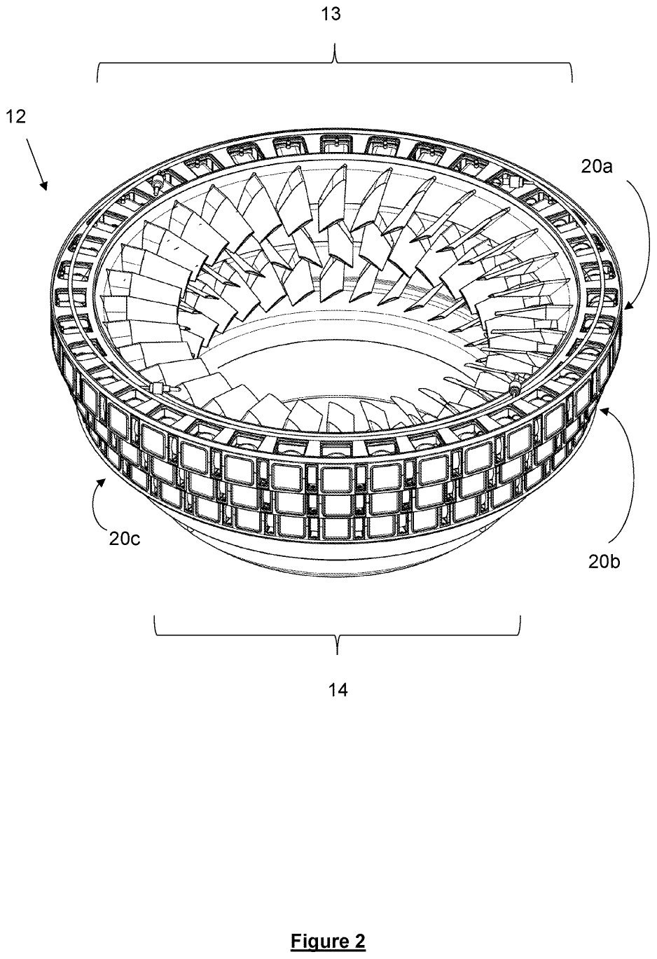

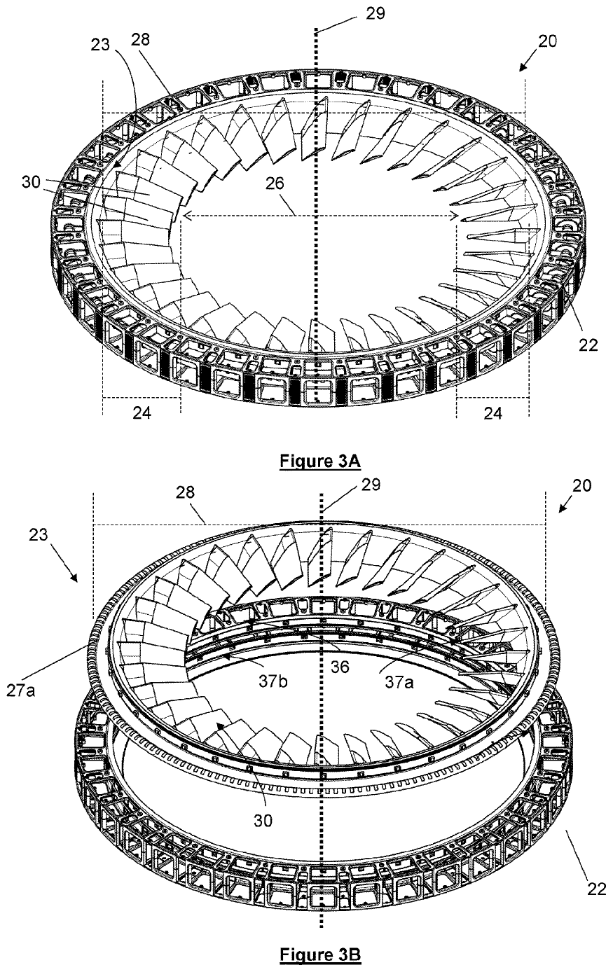

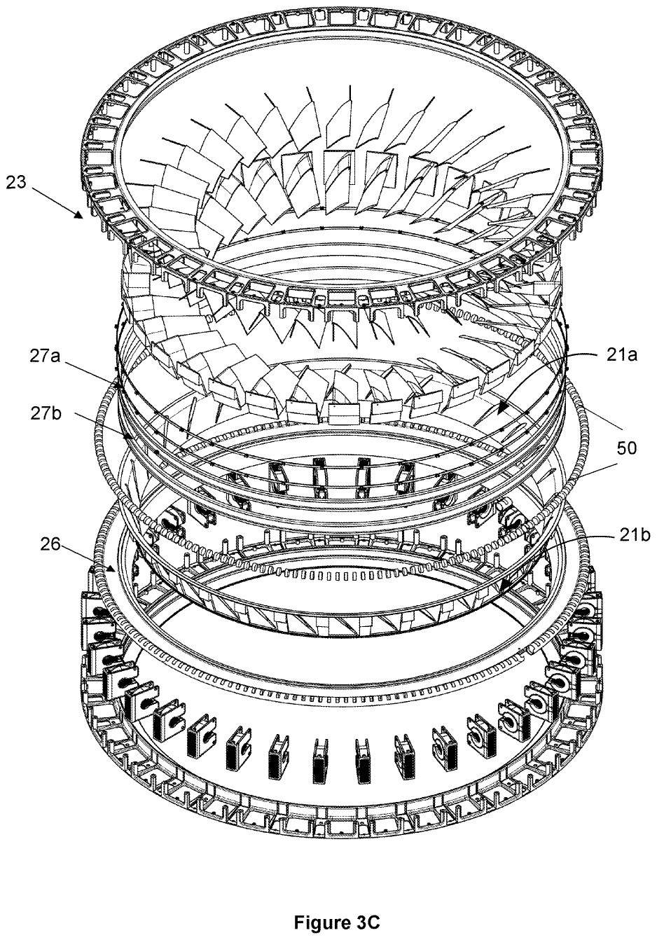

FIGS. 3A and 3B show an individual rotor stage 20 according to an embodiment. FIG. 3B is an exploded view of FIG. 3A. The rotor stage 20 comprises a fixed frame 22 and a substantially circular ring-shaped rotor 23. The rotor 23 is configured for rotation with respect to the fixed frame 22. The rotor 23 is located, in use, within a corresponding internal opening of the fixed frame 22 as shown. In an embodiment, the rotor 23 is electrically driven such that the fixed frame 22 is in effect a stator of an electric motor. The rotor 23 has an inner circumference (the diameter of the inner circumference is shown by reference 28) which is centred on a central axis 29. Rotation of the rotor 23 is about the central axis 29, which is perpendicular to a plane defined by the ring-shaped rotor 23. For example, in use with certain aircraft, the inner circumference 28 can have a corresponding diameter of around 1.5-2 metres. More generally, each rotor stage 20a-20c is associated with a corresponding central axis 29. In an embodiment, the central axes 29 of each of the rotor stages 20a-20c coincide and therefore represent the same axis. However, one or more of the central axes 29 can be offset and/or angled with respect to one or more other central axes 29 (not shown).

Mounted to the rotor 23 are a plurality of blades 30 The blades 30 are mounted to the rotor 23 at its inner circumference 28 and are arranged to extend towards the central axis 29. The blades 30 are arranged such as to define, internal to the inner circumference 28 of the rotor 23, an active region 24 in which the blades 30 move during rotation and a free region 26 in which the blades 30 do not move. For each rotor stage 20, its corresponding free region 26 represents an internal volume of the rotor stage 20 in which there is no mechanical interaction between the rotor stage 20 and the air moving through the rotor stage 20.

In an embodiment, the fixed frame 22 is formed, at least in part although preferably in whole, from a 3D printed titanium alloy advantageously having a sufficiently high strength and low weight for aeronautical usage.

FIG. 3C shows an exploded view of the rotor 23 of FIG. 3B. The rotor 23 comprises a circular blade mount 25, having a circular inside surface 21a and a circular outside surface 21b. Relevantly, the blade mount 25 is circular about the central axis 29 of the rotor 23 although the radius of both the inside surface 21a and the outside surface 21b can change in the direction parallel to the central axis 29. For example, as shown, the blade mount 25 tapers from top to bottom such that the radius of the inside surface 21a is smaller at the bottom of the blade mount 25 when compared to the top. The blade mount 25 can be formed from 3D printed titanium.

The rotor 23 comprises a circular magnetic flywheel 26 affixed to the outside surface 21b of the blade mount 25 (see FIG. 3C). In the embodiment shown, the magnetic flywheel 26 has a relatively planar annular configuration and is positioned at a relatively central position with respect to the blade mount 25 (see FIG. 3B).

The magnetic flywheel 26 comprises a plurality of magnets 50 located, in use, outside of the blade mount 25 on a flywheel base 55 (for example, the flywheel base 55 itself is not magnetic). The flywheel base 55 can be formed from 3D printed titanium. Typically, the plurality of magnets 50 are arranged along an imaginary circle with respect to the central axis 29, such that during rotation the magnets 50 all rotate around the central axis 29 at a common radius. The magnets 50 are preferably equally spaced around the imaginary circle. In an embodiment, the magnets 50 are each N52 neodymium magnets. Each magnet 50 has a north pole (N) and a south pole (S) at opposing ends, forming a N-S axis. In an embodiment, the magnets 50 are arranged with alternative orientations of their north and south poles and with their N-S axes aligned substantially with a tangent of the imaginary circle.

Referring to both FIGS. 3B and 3C, the fixed frame 22 and rotor 23 each comprise complementary bearing assembly structures 27, 37, such that when the rotor 23 is affixed to the fixed frame 22 it is substantially free to rotate about its central axis 29.

In the embodiment shown, the fixed frame 22 is provide with two axially separated outer bearing races 37a, 37b. The two outer bearing races 37a, 37b are separated by a gap defining a circular slot 36 which is a space extending into the body of the fixed frame 22. The slot 36 has a sufficient depth to accommodate the portion of the magnetic flywheel 26 external to the blade mount 25 when the ring assembly 23 is rotatably mounted to the fixed frame 22.

The rotor 23 comprises two inner bearing 27a, 27b separated axially at the outside surface of the ring assembly 23. The two inner bearings 27a, 27b, are arranged to physically interface with the two outer bearing races 37a, 37b.

In the embodiment shown, the inner bearings 27a, 27b are conductive roller bearings and can be formed from a beryllium copper alloy. The outer bearing races 37a, 37b are also conductive and can also be formed from a beryllium copper alloy. Advantageously, the use of the beryllium copper alloy may prevent EDM (electric discharge machining) and may improve electro thermal bearing rotation.

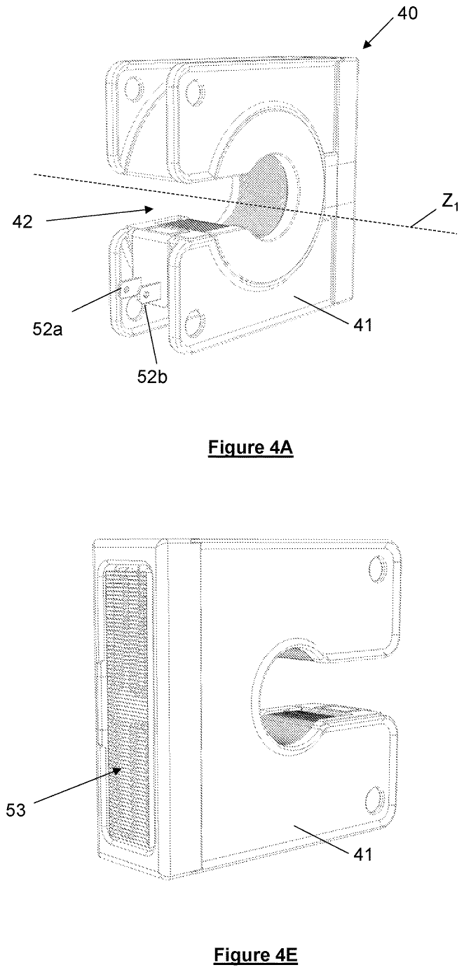

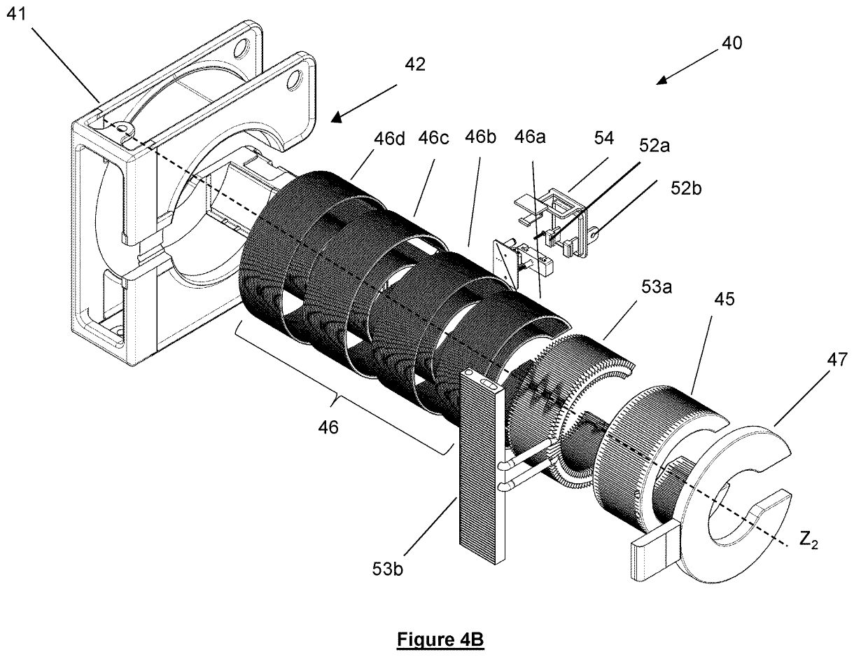

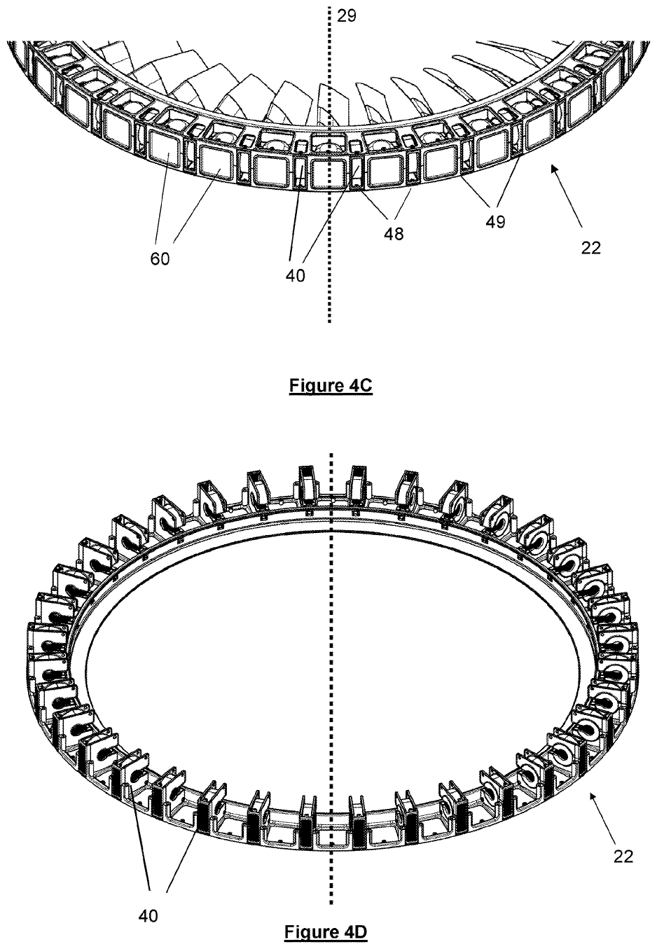

FIGS. 4A and 4B show an electromagnetic accelerator unit 40 according to an embodiment. FIG. 4B shows an exploded view of the accelerator unit 40 of FIG. 4A. The accelerator unit 40 comprises an accelerator unit housing 41 defining a C-shaped opening 42 such that, in use, the at least an outer portion of the rotor 23 is enabled to move, via rotation of the rotor 23, through the C-shaped opening 42. Therefore, the C-shaped opening 42 defines an axis Z₁ which, in use, is aligned substantially parallel to the tangent of the outside circumference of the rotor 23.

Referring to FIG. 4B (showing an exploded view of the accelerator unit 40 of FIG. 4A, the accelerator unit housing 41 is configured to house an electromagnetic element comprising a C-shaped core 45 and one or more (in the example shown, there are four) C-shaped coils 46. In the described embodiment, the C-shaped core 45 is an iron core and the C-shaped coils 46 are formed from copper wire. Both the shaped core 45 and C-shaped coil 46 define C-shaped openings which, when assembled, are aligned with the C-shaped opening 42 of the accelerator unit housing 41. At least one C-shaped end cap 47 is provided at a side of the accelerator unit housing 41 to retain the core 45 and coil 46 and optionally to provide access when required, such as for maintenance. The accelerator unit housing 41 and the end caps 47a, 47b can be formed from 3D printed polyetheretherketone (PEEK). The sides of the accelerator unit housing 41 can be understood by reference to axis Z₁, and form planes perpendicular to said axis Z₁. The iron core, copper coils 46, copper heat tube, and copper heat exchanger can be dual metal 3D printed in one unit for ease of assembly. The iron core can be designed to mitigate internal heating from eddy currents resulting from AC pole switching. The accelerator unit 40 can comprise control circuitry 56 accessible behind control circuity cover 54. The control circuity 56 can be configured to alter a mode of operation of the accelerator unit 40. In the case of plural C-shaped coils 46, these can be arranged such that a first C-shaped coil 46a is located within a second C-shaped coil 46b which is itself located within a third C-shaped coil 46c, etc (four C-shaped coils 46a-46d are shown in this arrangement in the figure).

As shown in FIGS. 4B and 4E, in an embodiment, the accelerator unit 40 of FIGS. 4A and 4B comprises a heat exchanger 53. In the example shown, the heat exchanger 53 comprising an internal heat exchanger element 53a and an external heat exchanger element 53b (for example, these can be separate physical elements in contact with one another, or the heat exchanger 53 can be integrally formed), where the internal heat exchanger element 53a is located proximal the C-shaped coil(s) 46 and the external heat exchanger element 53b is located on a rear surface of the accelerator unit housing 41 (i.e., such that the heat exchanger 53 in use faces away from the rotor 23).

Referring to FIG. 4C, in an embodiment, a plurality of accelerator units 40 are mechanically affixed to the fixed frame 22. For example, the number of accelerator units 40 can be 36. As shown, it can be preferred that the accelerator units 40 are located at substantially equal spacing around the circumference of the fixed frame 22. The fixed frame 22 comprises a corresponding plurality of accelerator unit mounting points 48 around its circumference. Therefore, the accelerator units 40 are mounted at the accelerator unit mount points 48 and optionally are removeable, when necessary (for example, for maintenance purposes), and if needed replaced, which may advantageously facilitate maintenance of the engine 10. The accelerator units 40 can be provided with a fault indicator (not shown), such as an LED light, for ease of troubleshooting (e.g., by enabling identification of a particular faulty accelerator unit 40 from the plurality of accelerator units 40). In use, each accelerator unit 40 is positioned with its C-shaped opening facing towards the central axis 29.

According to an embodiment, the spacing and sizes of the arrangement of magnets 50 and the axial length of the coils 46 (i.e. along axis Z₁ in FIGS. 4A and 4B) are selected such that, during operation, there is always one magnet 50 entering, one magnet 50 central, and one magnet 50 exiting a particular coil 46. The alternating arrangement of the magnets 50 (e.g. N-S, S-N, N-S, etc.) ensures an alternating phase profile of the magnetic field due to the movement of the magnets 50 through the accelerator units 40.

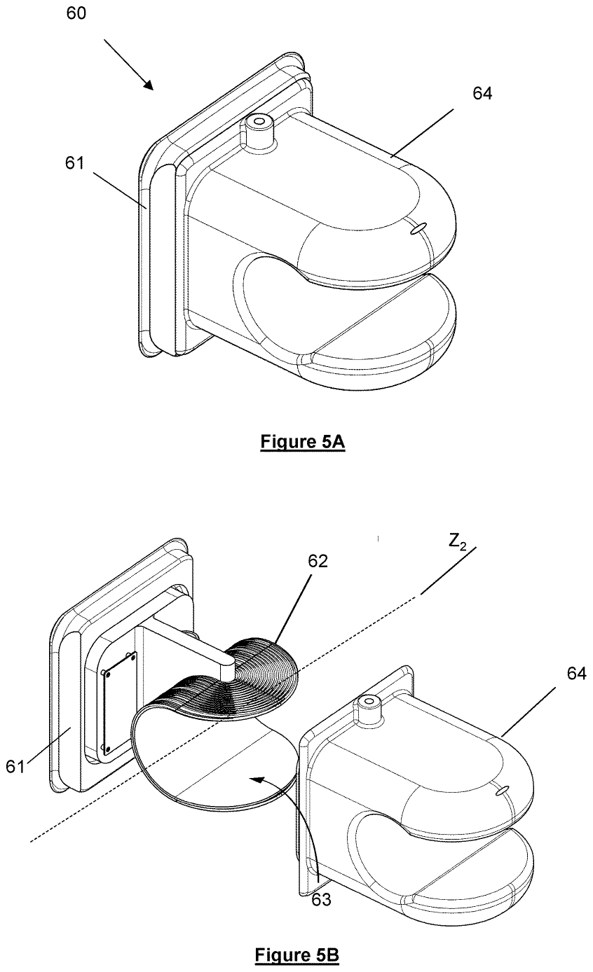

FIGS. 5A and 5B show a DC induction scavenge unit (ISU) 60, utilised in an embodiment. FIG. 5B shows an exploded view of the ISU 60 whereas FIG. 5A shows an external view of the ISU 60. The ISU 60 comprises an ISU mount 61 from which a C-shaped ISU coil 62 extends. The C-shaped ISU coil 62 is shaped such as to have an open end 63 distal to a mount point at which it is mounted to the mount 61. The ISU coil 62 comprises wire windings which are configured to generate electromagnetic induction due to the motion of the magnets 50 of the rotor 23 as the rotor 23 rotates. Therefore, each ISU 60 interacts with a continuously changing magnetic field, which thereby results in the generation of a current within the ISU coil 62. The open end 63 is therefore arranged facing the rotation axis of the rotor 23 such that the magnets 50 move substantially along the axis marked Z₂. An ISU cover 64 can be provided to protect the ISU coil 62. The ISU mount 61 and the cover 64 can be formed from PEEK.

The ISU 60 comprises an ISU electrical output circuit (“ISU output circuit”) 65, which typically comprises a capacitor 66 and an ISU controller 67 electrically coupled to the ISU coil 62.

Referring back to FIG. 4C, in an embodiment, a plurality of ISUs 60 are mechanically affixed to the fixed frame 22, for example, alternatingly with the arrangement of accelerator units 40. In this embodiment, the number of ISUs 60 can be the same as the number of accelerator units 40 (e.g. 36). Therefore, as shown, it can be preferred that the ISUs 60 are located at substantially equal spacing around the circumference of the fixed frame 22. The fixed frame 22 comprises a corresponding plurality of ISU mounting points 49 around its circumference such that the ISUs 60 can be mounted at the ISU mount points 49 and removed, when necessary (for example, for maintenance purposes), and if needed replaced.

FIG. 4D shows an alternative embodiment utilising the plurality of accelerator units 40 of FIGS. 4A and 4B, but not the ISUs 60 of FIGS. 5A and 5B. FIG. 4D shows the arrangement of accelerator units 40 mounted to the fixed frame 22 with a portion of the fixed frame 22 omitted.

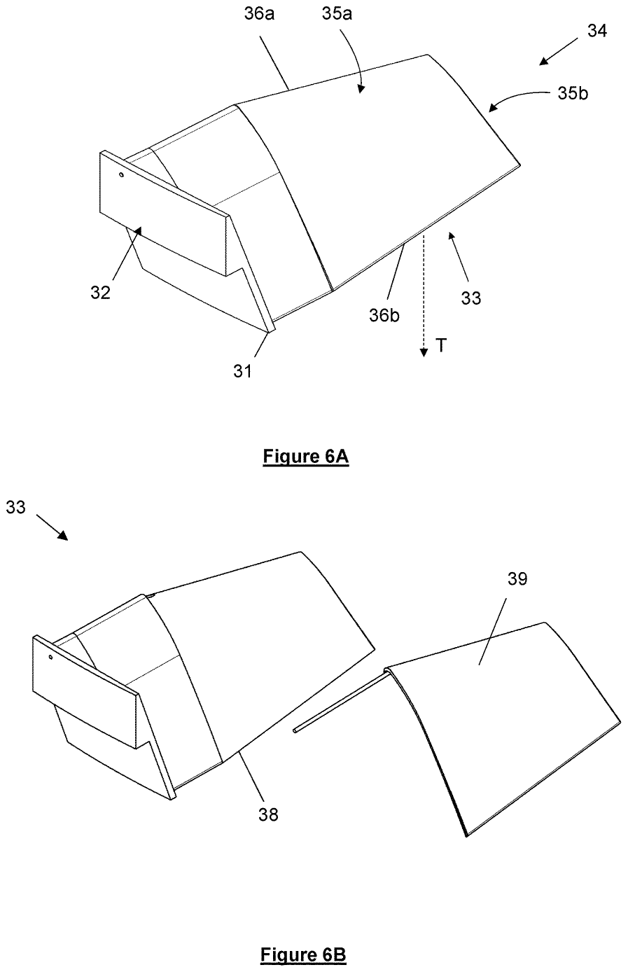

FIGS. 6A and 6B show a blade 30 according to an embodiment. In use, a plurality of blades 30 are mounted to the blade mount 25 as described with reference to FIG. 3A. Referring to FIG. 6A, each blade 30 comprises a proximal end 31 having an interface structure 32 for enabling the blade 30 to be mechanically affixed to the blade mount 25. A blade body 33 extends from the proximal end 31 and terminates at a distal end 34 of the blade 30, such that in use, the distal end 34 is the closest portion of the blade 30 to the central axis 29 of the rotor stage 20.

Each blade body 33 is shaped such as to have an angled bottom surface 35b with a leading top edge 36a and a trailing bottom edge 36b, both extending substantially from the proximal end 31 to the distal end 34. Each blade 30 further comprises a top surface 35a opposite its bottom surface 35b, such that in use the top surface 35a substantially faces towards the intake end 13 of the engine 10 and the bottom surface 35b substantially faces towards the exhaust end 14 of the engine 10. In use, the blade body 33 is mounted to the blade mount 25 such that, during rotation, the top edge 36a leads the bottom edge 36b, thereby producing thrust through reactive interaction with the air through which the blade 30 is moved. Each blade 30 therefore generates thrust directed away from the lower surface 35 (e.g. in the direction T as shown in FIG. 6A). The top surface 35a and bottom surface 35b can be shaped such as to define an aerofoil.

In the particular embodiment of FIGS. 6A and 6B, the blade body 33 varies such that the blade angle a varies from the blade root (proximal the interface structure 32) to the blade tip in a distributed pitch profile of approximately 45 degrees.

According to an embodiment, each blade 30 is configured to provide an electrical conduction path between its proximal end 31 and its distal end 34. Referring to FIG. 6B, showing an exploded view of the blade 30 of FIG. 6A, in an embodiment, the blade body 33 comprises a main portion 38 and a conduction portion 39. In the embodiment shown, the conduction portion 39 is located substantially at the top surface 35a of the blade body 33. Generally, the conductive portion 39 provides sufficiently low electrical resistance when compared to the blade body 33 such that current flow is effectively constrained to the conductive portion 39. Therefore, the main portion 38 is either electrically insulative or at least of sufficiently lower conductivity compared to that of the conductive portion 39 to ensure a substantive portion of the electrical current flow is confined to the conductive portion 39. In an implementation, the conductive portion 39 is formed from a beryllium copper alloy which advantageously provides a high electrical conductivity and sufficient strength for continuous operation. The alloy also advantageously shows good resistance to tarnish and adverse chemical reactions. The conductive portion 39 can be vacuum bonded onto the main portion 38; in the example of FIG. 6B, the main portion 38 is shaped with a recessed upper surface, and the conductive portion 39 is bonded at the recess. In this embodiment, the top surface 35a of the blade body 33 comprises both the main portion 38 and the conductive portion 39, which should be arranged to ensure a substantially continuous surface profile. In the embodiment shown, the conductive portion 39 is located substantially at the top edge 36 of the blade body 33. In an embodiment, the blade body 33 is formed from 3D printed titanium. The blade body 33 can comprise an internal structure print in order to reduce weight.

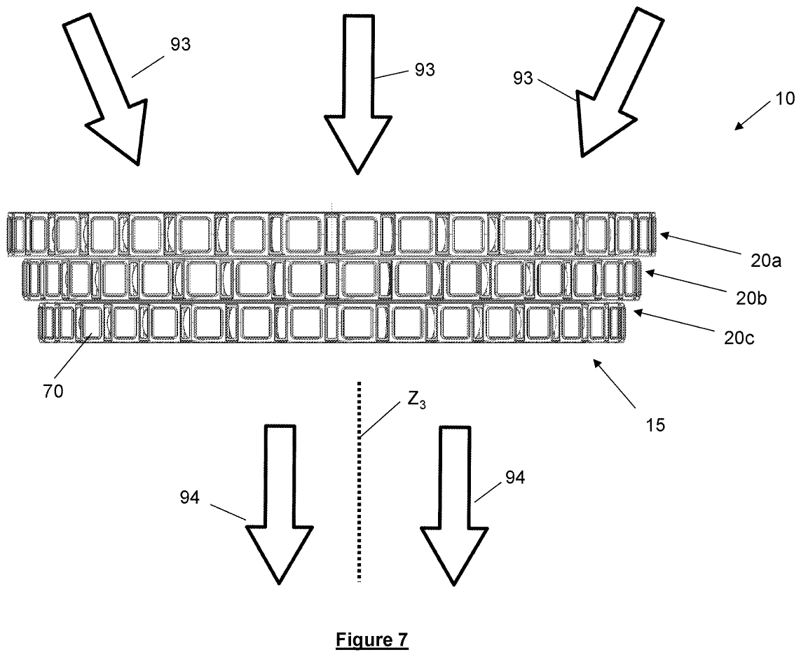

Referring to FIG. 7, according to an embodiment, the engine 10 comprises a support frame 15 having a substantially radially symmetric configuration thereby defining a central cylindrical axis Z₃ of the support frame 15. The support frame 15 defines a support frame airflow path 94 being the space enclosed by the support frame 15. In the implementation shown, the support frame 15 is substantially ring-shaped such that the support frame airflow path 94 is the internal area of the ring. According to the implementation shown, in use, the support frame 15 is affixed at a connection end 70 to the free end of the final rotor stage 20c. Notably, the support frame 15 is affixed to the final rotor stage 20c such as to form a continuous airflow path 92 from the rotor stage airflow path 93 through to the support frame airflow path 94.

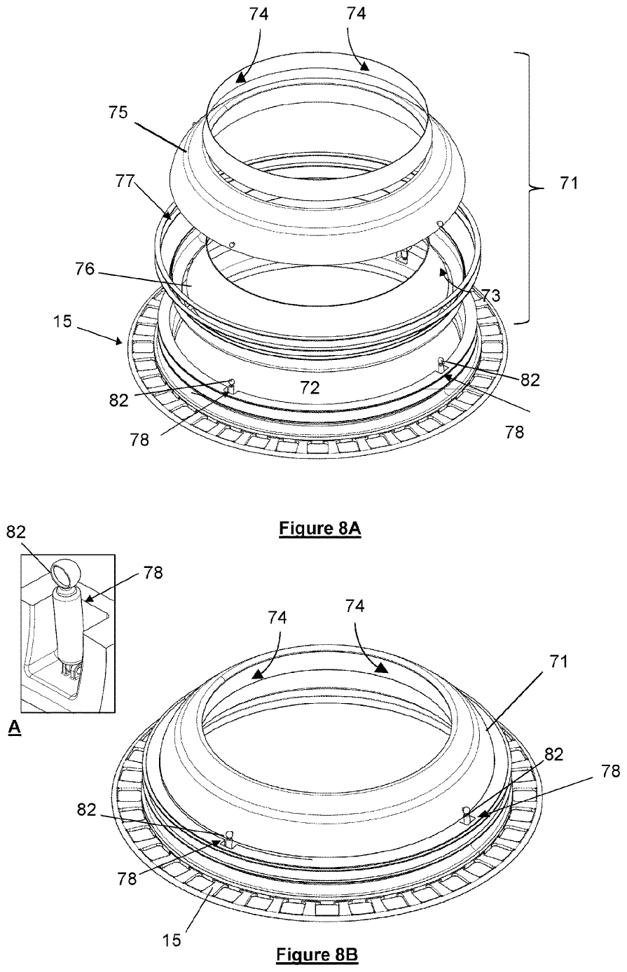

Referring to FIGS. 8A and 8B, according to an embodiment, the support frame 15 is configured to receive a nozzle assembly 71. Therefore, an internal surface 72 of the support frame 15 is shaped to provide a socket of a ball joint and a top surface 73 of the nozzle assembly 71 is shaped to provide a complementary ball joint stud of the ball joint. Thus, in use, the nozzle assembly top surface 73 interfaces with the support frame internal surface 72. In use, the nozzle assembly 71 is allowed a limited range of rotational motion with respect to the support frame 15 via the corresponding ball joint action. The nozzle assembly 71 further comprises an internal lower surface 74 which has a profile configured to provide a nozzle for the exhaust thrust of the engine 10. Therefore, the internal lower surface 74 faces the support frame airflow path.

In the embodiment shown, the nozzle assembly 71 comprises a top nozzle body 75 forming the top surface 73 of the nozzle assembly 71 and a bottom nozzle body 76 forming the lower surface 74 of the nozzle assembly 71. In use, the top nozzle body 75 and the bottom nozzle body 76 are affixed to one another and define a substantially sealed internal cavity 77. In an embodiment, one or preferably both of the top nozzle body 75 and bottom nozzle body 76 are formed from 3D printed titanium.

A rotation actuating means is provided for controlling rotation of the nozzle assembly 71 with respect to the support frame 15. In the embodiment shown, the rotation actuating means comprises a plurality of electrical actuators 78. In the embodiment shown in FIG. 8A, four electrical actuators 75 are provided arranged substantially symmetrically about the circumference of the support frame 15. In the embodiment shown, the support frame 15 comprises complementary slots for receiving each electrical actuator 78, such that a particular electrical actuator 78 is mounted within its corresponding slot. Each electrical actuator 78 comprises a moveable arm which is controllably extendable in a direction away from the support frame 15. Typically, each electrical actuator comprises a fixed base which holds its moveable arm while allowing for movement of the arm. Each moveable arm comprises a nozzle coupling 82 for coupling the moveable arm to the nozzle assembly 71. In the embodiment shown, the nozzle coupling 82 is coupled to the bottom nozzle body 75. Therefore, relative movement of the moveable arms 80 results in a corresponding rotation of the nozzle assembly 71 with respect to the support frame 15, constrained as described by the effective ball joint formed between the top surface 73 of the nozzle assembly 71 and the internal surface 72 of the support frame 15. Generally, the moveable arms are moved in complementary fashion, for example, one may be extended while an opposite one is retracted, to thereby cause a net rotation of the nozzle assembly 71. Insert A of FIG. 8B shows an electrical actuator 78 including nozzle coupling 82 with surrounding portions of the engine 10 omitted.

Advantageously, rotation of the nozzle assembly 71 thereby alters the output thrust direction of the engine 10. That is, the nozzle assembly 71 is rotatable such as to controllably change the direction of airflow through the support frame airflow path 94 with respect to the direction of airflow through the rotor stage airflow path 93, thereby providing a vectored thrust output.

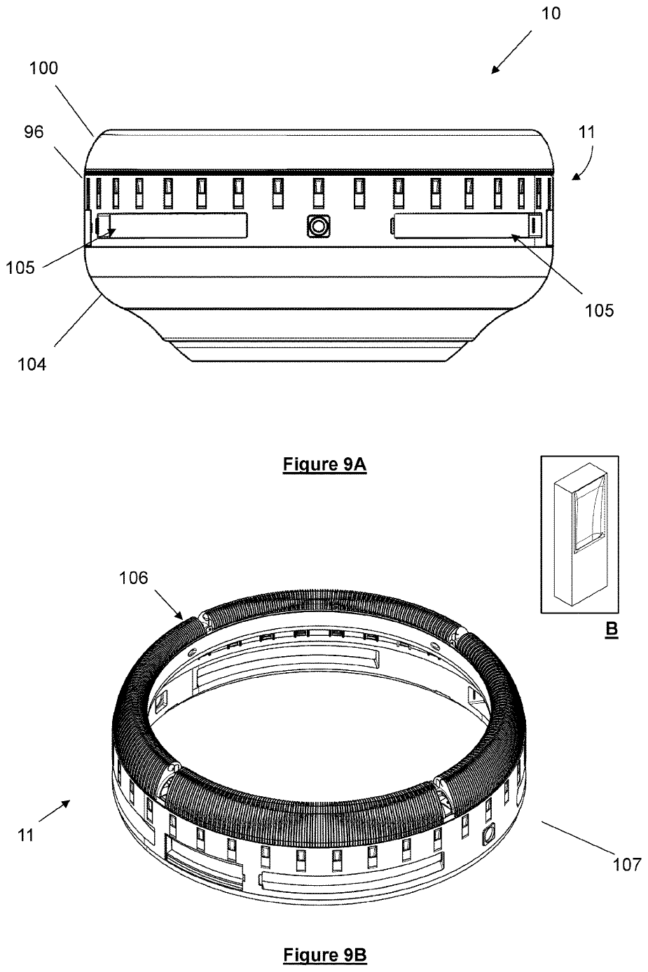

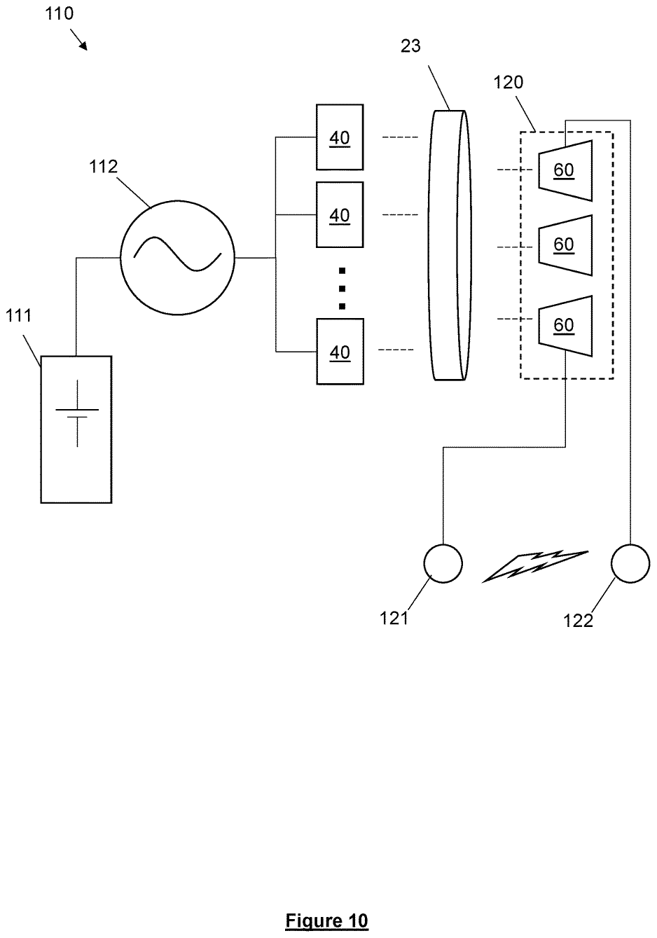

Referring to FIG. 9A (which shows a side-view of the engine 10 of FIG. 1A), according to an embodiment, the body 11 comprises a ring-shaped structure 96. When assembled, t the rotor assembly 12 is located within the ring-shaped body 11 (e.g., as shown in FIG. 1A). Typically, the rotor assembly 12 is positioned within the body 11 such that at least one of the rotor stages 20 is mechanically affixed to the body 11, e.g. via the fixed frame 22 of at least one of the rotor stages 20.

Although not shown in FIG. 9A, in an embodiment, the support frame 15 of FIGS. 8A and 8B are effectively also mounted to the body 11 via being affixed to the third rotor stage 20c. In another embodiment (not shown), the support frame 15 is directly affixed to the body 11.

Still referring to FIG. 9A, to the top of the body 11 is affixed an intake duct 100 (i.e. the intake duct 100 is located at the intake end 13 of the engine 10) which is configured, in an embodiment, for aerodynamic profiling to assist with improving intake airflow volume via the Coandă effect (e.g. by suitable shaping of the internal surface 101 of the intake duct 100). The intake duct 100 can comprise an intake support frame (not shown) which is configured for mechanical affixing to the first rotor stage 20a.

Referring to FIG. 9B, in an embodiment, the intake duct 100 houses a conduction heating system 106 for de-icing. The intake duct 100 is omitted from this figure. The conduction heating system 106 is electrically powered (e.g., by battery 111—see discussion in relation to FIG. 10). FIG. 9B also shows, according to an embodiment, a plurality of cooling ducts 107 (a single cooling duct 107 is shown in insert B) arranged around the external surface of body 11.

Also shown is an acoustic liner 102 to assist with noise reduction. In an embodiment, the acoustic liner 102 is 3D printed from titanium in a perforated design and filled with expansion foam for lightweight noise repression.

Also shown is exhaust shroud assembly 104 which in use is located proximal the exhaust end 14 of the engine 10. In an embodiment, at least a portion of the support frame airflow path 94 is surrounded by the exhaust shroud assembly 104 which has a tapered cross-section and can be formed from an insulated carbon fibre. In an embodiment, the bottom nozzle boy 76 of the nozzle assembly 71 extends slightly past the exhaust shroud assembly 104.

FIG. 10 shows a schematic representation of the electrical power system (“power system”) 110 of the engine 10. The illustrated power system 110 represents operation of the engine 10 when generating thrust, which herein is referred to as a “thrust mode”. In an embodiment, as described below, the engine 10 is switchable to an “energy recovery mode” in which electrical energy is generated from the rotational inertia of the rotor stages 20 when decelerating (i.e. when thrust is not required, such as after landing of the aircraft).

Considering the engine operating in its thrust mode, battery 111 provides a D/C electrical power supply. The battery 111 is electrically coupled to an alternating current power generator (“A/C generator”) 112 configured to generate an alternating electric current output. In an embodiment, the A/C generator 112 is configured for generating the A/C output with at least one controllable parameter, for example, having a controllable A/C frequency.

The A/C output is electrically coupled to the plurality of accelerator units 40. Due to the complementary arrangement of N-S magnets 50 of the rotor 23 and accelerator units 40 affixed to the fixed frame 22, a torque is applied to the rotor 23 due to the electromagnetic force imparted onto the magnets 50 due to the A/C current flow through the accelerator units 40. Notably, the rotation rate of the rotor 23 is proportional to the A/C frequency. In effect, each accelerator unit 40 alternates between applying a push and a pull force to the magnets 50 of the rotor 23 as the magnets 50 move into, through, and out of the accelerator units 40.

Referring back to FIGS. 4A and 4B, the accelerator units 40 can be provided with first and second conductive pins 52a, 52b extending from the accelerator unit housing 41. The first and second conductive pins 52a, 52b are configured to insert into complementary first and second sockets (not shown) of the fixed frame 22. Therefore, in an embodiment, a plurality of first and second sockets are located around the fixed frame 22, for example, a pair comprising one first socket and one second socket can be located at each of the accelerator unit mounting points 48. The sockets are electrically coupled to the A/C generator 112 such that, in use, A/C electrical power is provided to the pins 52 of each of the plurality of accelerator units 40 via the corresponding sockets. The first sockets can be electrically coupled to one another, for example, in either a series or parallel configuration. Similarly, the second sockets can be electrically coupled to one another, for example, in either a series or parallel configuration. Electrically coupling the first sockets to one another and the second sockets to one another ensures that the same phase of A/C electrical power is provided to each accelerator unit 40.

In the embodiment comprising one or more ISUs 60, these are arranged to generate electrical energy from the movement of the magnets 50 through the ISUs 60, thereby generating an electromagnetic force (emf) via the interaction between the magnets 50 and the ISU coils 62. In an embodiment, the ISUs 60 are electrically coupled to a rectification circuit (not shown) configured to convert the emf into a relatively smooth DC current. Each ISU 60 can comprise its own rectification circuit or a single rectification circuit can be provided to rectify the combined electrical output of the ISUs 60.

A high voltage supply 120 is provided for generating a plasma arc. The high voltage supply 120 is represented in FIG. 10 as terminating at a first electrode 121 and at a second electrode 122 of opposite polarity to the first electrode 121. Relevantly, the first electrode 121 and second electrode 122 are physically separated by the airflow path 92 of the engine 10. In order to complete the DC circuit, a plasma arc is generated within the airflow path 92. In order to generate a plasma arc, the high voltage supply 120 is configured to generate a sufficient DC voltage, at least during certain operating conditions of the engine 10. For example, when the rotation rate of the rotors 23 is sufficiently high.

In an embodiment, the high voltage supply 120 corresponds to the electrical output of the ISUs 60. In an implementation, the ISUs 60 are arranged to generate a sufficient emf to generate a plasma arc by configuring the ISU coils 62 in accordance with an expected operating rotation rate (e.g. RPM) or range of operating rotation rates of the magnetic flywheel 19. For example, the generated emf can be dependent on the number of windings of the ISU coils 62 and the rate of change of magnetic field experienced by the ISU coils 62, which is itself dependent on the rotation rate of the magnetic flywheel 19. Therefore, a required output emf of the ISUs 60 can be configured based on a number of coil windings. Furthermore, groupings of two or more ISUs 60 can be arranged electrically in series to effectively add the emf generated by the individual ISU coils 62 of the group. In another implementation, a voltage step up converter is provided for increasing the voltage from that of the emf generated by the ISUs 60. For example, if the voltage step up converter is controllable, the output voltage can be controlled such as to be effectively independent of the emf voltage of the ISUs 60. This may advantageously allow control to increase the output voltage in the event that the conditions for plasma arcing are determined, for example by a sensor arrangement, to be near a cut-off condition (for example, due to changes in the atmospheric properties such as moisture content).

In another embodiment, the high voltage supply 120 is coupled to the battery directly or preferably via a voltage step up converter. In this embodiment, the ISUs 60 can still be provided for electromagnetic breaking purposes (i.e. to obtain energy from the flywheels 19 during spin down of the rotors 23), although the ISUs 60 may be omitted, for example, the plurality of accelerator units 40 can be utilised to provide electromagnetic breaking and thereby obtain energy from the flywheels 19 during spin down of the rotors 23.

The first electrode 121 can be configured as a cathode. Physically, the first electrode 121 corresponds to the conductive portions 39 of the blades 30 of the rotor stages 20. The blades 30 are electrically coupled to the high voltage supply 120 via the conductive inner bearings 27 and outer bearing races 37. That is, the blades 30 are electrically coupled to the conductive inner bearings 27 which themselves are electrically coupled to the outer bearing races 37. Therefore, an electrical path is provided between the blades 30 and the high voltage supply 120 during rotation of the rotors 23.

The second electrode 122 can be configured as an anode. Physically, the second electrode 122 is located near the exhaust end 14 of the engine 10. In this way, the plasma arc generated by the potential difference between the first electrode 121 and the second electrode 122 can be directed through a substantial portion of the airflow path 92 as the blades 30 are located within the rotor stage airflow path 93.

In an embodiment, the second electrode 122 is associated with the nozzle assembly 71. As previously described, the top nozzle body 75 and bottom nozzle body 76 combine to form a hollow structure (e.g. see internal cavity 77 of FIG. 8B).

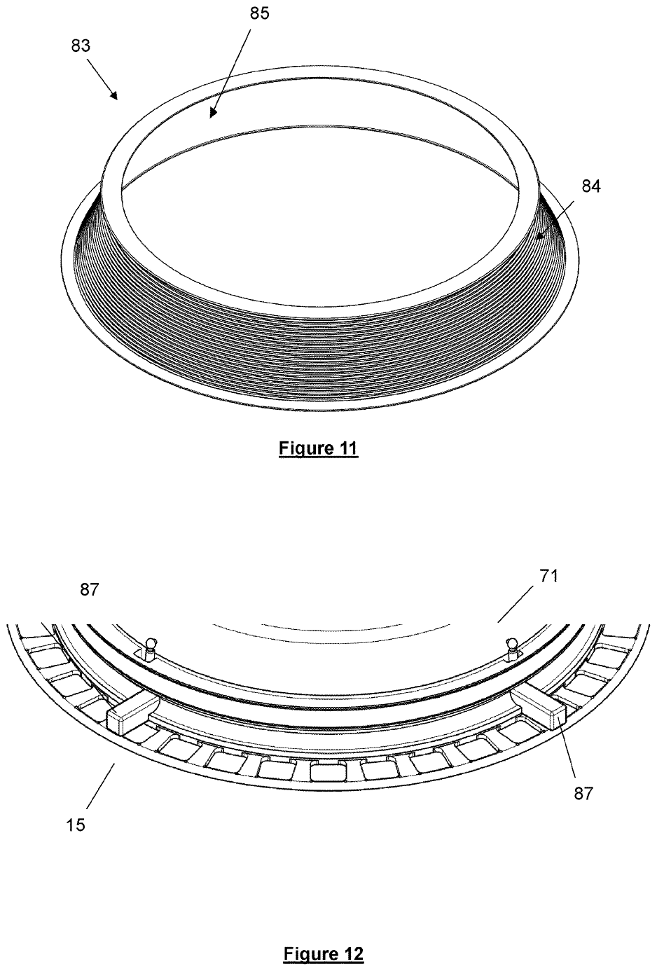

FIG. 11 shows an embodiment comprising a solenoid assembly 83 which, in use, is located within the internal cavity 77. The solenoid assembly 83 comprises a wire winding 84 about a core 85. The core 85 is a substantially cylindrically symmetrical ring and the wire winding 84 is correspondingly cylindrically symmetric. The core 85 (and therefore the wire winding 84) can be tapered such that the portion of the winding 84 located, in use, closer to the intake end 13 of the engine 10 has a larger radius than that located closer to the exhaust end 14, such that the core profile follows that of the nozzle assembly 71. The winding 84 is therefore radially symmetric. The wire winding 84 is therefore arranged as a solenoid. Also provided is a ceramic heat shield 86 having a similar shape to the core 83 and positioned such as to shield the winding 84 from the heat of the exhaust airflow. The wire winding 84 is electrically coupled to the high voltage supply and effectively corresponds to the second electrode 122. A conductive ring (not shown) can be provided near or at the exhaust end 14 of the nozzle assembly 71 which is electrically coupled to the wire winding 84 to thereby provide a conductive path between the plasma arc and the solenoid assembly 83. In an embodiment in which the nozzle assembly 71 is formed from 3D printed titanium, the conductive ring is of sufficiently higher conductivity compared to the nozzle assembly 71 that the conductive ring carries substantially all electrical current related to the plasma arc.

In another embodiment, the second electrode 122 corresponds to a conductive portion of the nozzle body 75, without the use of a solenoid assembly 83 or the like. The conductive portion can be a conductive ring (not shown) located at or near the exhaust end 14 of the nozzle assembly 71. The conductive portion is electrically coupled to the high voltage supply 120. Advantageously, the engine 10 overall weight can be reduced by omitting the solenoid assembly 83.

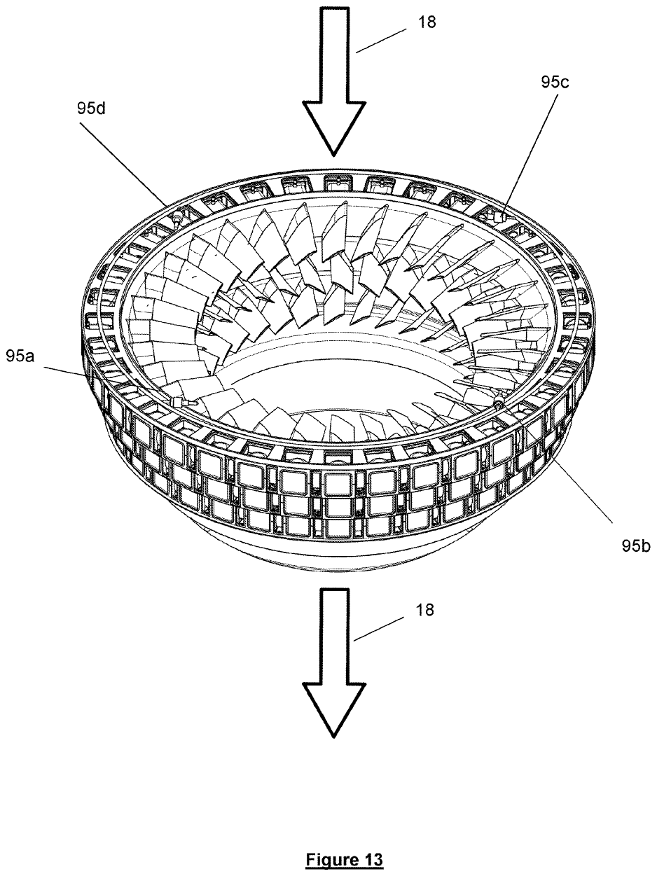

Referring to FIG. 12, in an embodiment, one or more cavity magnetrons 87 are provided to assist with generating the plasma arc. For example, four magnetrons 87 can be arranged about the support frame 15 (specifically, an annular flange portion of the support frame 15 forming the connection end 70); in the figure, two magnetrons 87 are shown. The magnetrons 87 can be substantially equally spaced around the outside of the nozzle assembly 71. The magnetrons 87 each comprise a transformer and containment magnet arrangement and arranged to direct microwave energy into the support frame airflow path 94. Therefore, the support frame 15 can comprise microwave transparent portions (which can be openings) through which the microwave energy of the magnetrons 87 is directed. The support frame 15 can be provided with a microwave reflector (not shown) designed to focus the microwaves emitted from the magnetrons 87 within the support frame airflow path 94. The microwave reflector can be a concave metal shroud. The magnetrons 87 can be controlled such that specific magnetrons 87 are active only when the rotation of the nozzle assembly 71 allows for direction of the microwave energy into the support frame airflow path 94.

Referring back to FIG. 1, during operation (where applicable, in its thrust mode), the engine 10 generates thrust through rotation of the rotors 23, which generate movement of airflow via the motion of the blades 30 of each rotor 23 into the intake end 13, through the airflow path 92, and out of the exhaust end 14 of the engine 10. The net result is the generation of thrust by the engine 10 directed away from the exhaust end 14. The relative shapes of the intake duct 100 and the exhaust nozzle assembly 71 act to provide additional thrust efficiency due to the acceleration due the relatively smaller internal diameter of the nozzle assembly 71 when compared to the diameter of the intake duct 100.

Without intending to be bound to any particular theory, the rotor stages 20 can generate an inductive airflow effect within at least a portion of the airflow path 92. In particular, the blades 30 of each rotor stage 20 generate airflow within the active region 24 of each rotor stage 20 via the direct interaction between the blades 30 and air. The inductive airflow effect is expected within the free region 26 of each rotor stage 20 due to aerodynamical effects associated with creation of a relatively low central pressure within the airflow within the free region 26 which acts to pull in a larger amount of atmospheric air than that directly due to the movement of the blades 30.

In addition, during operation, the high voltage supply 120 is arranged to create a sufficient electrical potential difference such that a plasma arc is generated between the blades 30 (for example acting as a cathode) and the nozzle assembly 71 (for example acting as an anode). The plasma arc causes heating of the airflow in the vicinity of the plasma arc, thereby increasing the temperature of the airflow such that the exhaust airflow is at a higher temperature than the air entering the engine 10 at the intake duct 100.

Without intending to be bound to any particular theory, it is believed that the higher temperature exhaust compared to the intake airflow generates improved thrust due to the resulting velocity increase of the airflow and static pressure reduction.

In an embodiment, the rotor stages 20 are arranged with alternating directions of rotation (i.e. of the respective rotors 23). For example, first and third rotor stages 20a, 20c have rotors 23a, 23c driven in a first rotation direction while second rotor state 20b has a rotor 23b driven in a second, opposite, rotation direction. Although the rotor stages 20 all generate downward thrust, the alternating rotational directions act to create vortices extending away from the blades 30 towards the central axes 29 of the rotor stages 20. These vortices provide a preferred ionisation pathway for the plasma arc, such that the plasma arc is directed towards the central axis 29.

The pathway then extends downward towards the nozzle assembly 71 due to the potential difference. Advantageously, the solenoid (i.e. due to wire winding 84) can act to, in effect, funnel the plasma arc through a substantial portion, if not all, of the support frame airflow path 94, while also providing an electrical contact point for terminating the plasma arc.

Again, without intending to be bound to any particular theory, the engine 10 is expected to make use of Markland convection where, in the presence of an electrical potential difference between the first electrode 121 and the second electrode 122, a self-organising alignment of the airflows ionisation energy levels occurs within the vortices (known as Markland Convection) that creates a conductive pathway between the two electrodes 121, 122.

Advantageously, the solenoid, when utilised, may also assist in confining a substantial portion of the plasma within the support frame airflow path 94. Therefore, heating due to the plasma primarily occurs within the exhaust airflow and the plasma is kept away from physical components of the engine 10, thereby reducing or even eliminating conductive heating of the engine 10 by the plasma while also maximising the heat transfer to the airflow.

In an embodiment the engine 10 is controllable to operate in an energy recovery mode. The energy recovery mode is an alternative mode of operation to the thrust mode, generally, the engine 10 cannot simultaneously operate in both modes. In the energy recovery mode, the operation of the accelerator units 40 and optionally the ISUs 60 is controllably altered such as to act as electromagnetic brakes to the rotation of the rotors 23. The A/C supply to the accelerator units 40 is removed, and the accelerator units 40 are controlled (e.g. via a relay system) to operate as a DC coil to convert the mechanical rotational energy of the rotors 23 into electrical energy (a DC current) via induction due to the motion of the magnets 50. If used, the ISUs 60 may not require a change of configuration as such, as these are already configured for generating a DC current. The DC current thereby produced can be utilised for charging the battery 111. Referring back to FIG. 4B, the control circuitry 46 can be configured to cause a change of operation of an accelerator unit 40 between the thrust mode and the energy recovery mode.

In an embodiment, with reference to FIG. 9A, the engine 10 comprises one or more capacitor banks (not shown). Although the capacitor banks are not shown, capacitor mounts 105 are shown as an element of body 11 (therefore, in the embodiment shown, four capacitor banks can be provided). Each capacitor bank is configured as a super capacitor bank.

In an embodiment, three of the capacitor banks are electrically coupled to the three rotor stages 20 (one per rotor stage 20) and are configured to provide additional electrical power when required, such as at take-off and landing of an aircraft. Advantageously, by providing an independent capacitor bank for each rotor stage 20, redundancy is provided to mitigate against failure of a rotor stage 20 or a capacitor bank. Therefore, each capacitor bank should provide sufficient electrical energy to satisfy the additional energy requirements of the engine 10 during those times when it is necessary.

In an embodiment, a capacitor bank is electrically coupled to the one or more magnetrons 87 to provide at least a portion of the electrical power required.

In an embodiment, the nozzle assembly 71 and rotor assembly 12 are electrically isolated from one another, for example, via an insulating stopper (not shown) located between the support frame 15 and the bottom rotor stage 20 (e.g. third rotor stage 20c in the embodiments shown in the figures). Similarly, in an embodiment, each of the rotor stages 20 can be electrically isolated, for example, via insulating stoppers (not shown) located between adjacent rotor stages 20. In this way, inadvertent shorting between first and second electrodes 121, 122 may be avoided.

Referring to FIG. 13, in an embodiment, a water injection assembly comprising one or more water injectors 95 are arranged for injecting (e.g., spraying) water into the airflow near the intake end 13. The one or more water injectors 95 can be located within the intake duct 100 (in the figure, the locations of the water injectors 95 are shown, although it should be understood that the intake duct 100 in practice obscures the water injectors 95 when viewed externally). In the figure, there are four water injectors 95a-95d arranged at 90-degree intervals. A water reservoir (not shown) can be provided with the propulsion engine 10. Alternatively, the water reservoir can be externally located (e.g., within an attached aircraft) and water supplied via suitable piping.

Again, without intending to be bound to any particular theory, it is expected that injection of water into the flow path 18 by the water injection assembly can cool and increase the air density within the flow path 18 to thereby increase induction airflow. Additionally, the water vapour within the flow path 18 can undergo electrolysis due to engagement with the plasma discharge, which can separate the constituent hydrogen and oxygen from each other. It is expected that, due to the polar nature of both elements, each follows a respective conductive pathway until ignition occurs through the centre of the engine 10. Advantageously, it may be that this embodiment can safety store hydrogen as water to be used for combustion in the presence of the plasma for high speed and high load requirements, offering a simple and safe alternative to cryogenic storage.

Further modifications can be made without departing from the spirit and scope of the specification.

1. (canceled)

2. (canceled)

3. (canceled)

4. The reaction engine of claim 26, wherein the mechanical thrust generator comprises a rotor assembly comprising one or more rotor stages, each rotor stage comprising:
a ring-shaped rotor having an internal volume encompassing at least part of the first airflow path portion and defining a central axis about which the ring-shaped rotor rotates, wherein the ring-shaped rotor is controllably driven for generating acceleration of the fluid; and
an arrangement of blades about an inner circumference of the ring-shaped rotor, each blade of the arrangement of blades extending inwards from the ring-shaped rotor by a distance smaller than a radius of the ring-shaped rotor,
wherein the active region corresponds to a volume of the first airflow path portion through which the arrangement of blades moves during rotation of the ring-shaped rotor, wherein the arrangement of blades is thereby configured to cause acceleration of the fluid within the active region, and
wherein the free region corresponds to a remaining volume of the first airflow path portion.

5. The reaction engine of claim 4, wherein the rotor assembly comprises a plurality of said one or more rotor stages arranged in axial flow sequence to generate inductive airflow within the free region due to the fluid acceleration within the active region of the one or more rotor stages.

6. (canceled)

7. The reaction engine of claim 5, wherein a first one of the plurality of rotor stages is an input rotor stage located proximal the intake end of the reaction engine and a final one of the plurality of rotor stages is an output rotor stage located proximal the exhaust end of the reaction engine, and wherein the first airflow path portion corresponds to a combination of internal volumes of the plurality of rotor stages, wherein each of the plurality of rotor stages is associated with a rotation direction corresponding to the direction in which its rotor is configured for rotation in order to cause acceleration of the fluid towards the exhaust end,
wherein the plurality of rotor stages are arranged in a sequence of alternating rotation directions.

8. (canceled)

9. (canceled)

10. The reaction engine of claim 4, wherein the arrangement of blades of each rotor stage are configured such that an interaction between adjacent rotor stages is such as to generate opposing vortices directed towards central axes of the adjacent rotor stages; and/or
wherein each blade of the arrangement of blades comprises a structure configured to induce vortices due to a difference in fluid flowrate from a root of the blade to a tip of the blade between a lower surface of the blade and an upper surface of the blade; and/or
wherein each blade of the arrangement of blades comprises a variable blade angle that changes between a root of the blade and a tip of the blade, with a distributed pitch profile of around 45 degrees.

11. (canceled)

12. The reaction engine of claim 7, wherein the output rotor stage has a smaller free region than that of the input rotor stage; and wherein a rotor of the output rotor stage has a smaller inner circumference than that of a rotor of the input rotor stage.

13. The reaction engine of claim 4, wherein of each rotor stage comprises a support frame, and wherein the rotor of the each respective rotor stage being rotatably mounted to the support frame of the particular rotor stage.

14. The reaction engine of claim 13, wherein each support frame comprises an annular support frame bearing structure and wherein the corresponding rotor comprises a complementary annular rotor bearing structure, and wherein the rotor is rotatably mounted to its corresponding support frame via an interface between the annular support frame bearing structure and the complementary annular rotor bearing structure.

15. (canceled)

16. (canceled)

17. The reaction engine of claim 16, wherein each support frame bearing structure and complementary rotor bearing structure are electrically conductive and provide an electrical connect between the corresponding support frame and rotor;
and/or
wherein one or both of:
the support frame bearing structure is formed, at least in part, from an electrically conductive beryllium copper alloy; and
the rotor bearing structure is formed, at least in part, from an electrically conductive beryllium copper alloy.

18. (canceled)

19. The reaction engine of claim 4, wherein the rotor of each rotor stage is driven by a controllable electromotive force and for this purpose at least one rotor comprises an arrangement of magnets proximal to an outside circumference of the rotor, and wherein its corresponding support frame comprises an arrangement of one or more accelerator units configured to generate the controllable electromotive force.

20. (canceled)

21. The reaction engine of claim 19, comprising, for each rotor stage, a plurality of the one or more accelerator units arranged at substantially equal spacing around an inside circumference of the corresponding support frame, wherein the plurality of the one or more accelerator units are configured to produce an electromagnetic force using AC electrical power received from an AC power supply.

22. (canceled)

23. The reaction engine of claim 21, wherein a rotation rate of each rotor is controllable, at least in part, by control of a frequency of the received AC electrical power; and/or
further comprising a battery electrically coupled to an alternating current generator configured to generate the AC electrical power based on a DC battery power supply, wherein the alternating current generator is controllable such as to control at least one parameter of the generated AC electrical power.

24. (canceled)

25. (canceled) 26. A reaction engine for producing thrust with respect to an intake fluid, wherein the intake fluid is configured to move from an intake end to an exhaust end of the reaction engine along an enclosed airflow path, the reaction engine comprising:
a thrust generating assembly for generating acceleration of an intake fluid within a first airflow path portion of an enclosed airflow path, wherein the thrust generating assembly comprises:
an input end for receiving the intake fluid;
an output end for delivering accelerated fluid; and
a mechanical thrust generator for generating for generating acceleration of the fluid within an active region of the first airflow path portion, wherein the first airflow path portion comprises a free region separate to the active region, wherein the thrust generating assembly is configured to cause inductive airflow within the free region due to airflow within the active region;
an airflow heating arrangement comprising a plasma arcing generator configured for generating a plasma arc within at least a portion of a second airflow path of the enclosed airflow within the airflow heating arrangement and to thereby cause a substantive temperature increase of the fluid;
before the fluid that received a substantive temperature increase exits the reaction engine at an exhaust end of the reaction engine to thereby provide thrust.

27. The reaction engine of claim 26, wherein the plasma arcing generator comprises a first electrode and a second electrode, wherein the first electrode is located spaced apart from the second electrode such as to generate an electrical potential difference within the second airflow path.

28. The reaction engine of claim 4, wherein the plasma arcing generator comprises a first electrode and a second electrode, the first electrode and the second electrode are spaced apart from one another to generate an electrical potential difference within the second airflow path, and wherein one or more of the blades of at least one of the rotor stages is/are electrically conductive and provide the first electrode of the plasma arcing generator.

29. The reaction engine of claim 28, wherein each of the one or more electrically conductive blades comprises an electrical connector at its root being electrically coupled to a rotor contact of its corresponding rotor stage configured to provide an electrical contact at an outside circumference of the rotor of the respective rotor stage.

30. (canceled)

31. The reaction engine of claim 28, comprising a nozzle assembly located and configured to receive the fluid flow from the rotor assembly, wherein the fluid exits the reaction engine from the nozzle assembly, and wherein the nozzle assembly comprises conductive structure corresponding to the second electrode.

32. (canceled)

33. (canceled)

34. The reaction engine of claim 31, wherein the second electrode comprises a conductive ring to provide a contact point for the plasma arc, wherein the nozzle assembly comprises the conductive ring; and/or
wherein the nozzle assembly has an internal profile for causing a nozzle effect on the airflow exiting the reaction engine, such that the internal profile cause acceleration of the heated fluid; and/or
wherein the nozzle assembly comprises solenoid formed by a conductive wire wound around a core, the solenoid defining an internal solenoid volume bounded by the core through which at least a part of the second airflow path portion is located, such that the solenoid is arranged to generate a magnetic field within the second airflow path portion when an electric current is present within the wire, and wherein the first electrode and second electrode are separated by the solenoid internal volume such that the plasma arc extends through said solenoid internal volume.

35. (canceled)

36. The reaction engine of claim 34, wherein the solenoid is electrically coupled to the second electrode; and/or
wherein the nozzle assembly is controllably rotatable with respect to the rotor assembly to provide a vectored thrust, wherein the nozzle assembly comprises a body defining an internal cavity, and wherein the solenoid is located within the internal cavity such that the solenoid is rotated with the nozzle assembly.

37. (canceled)

38. (canceled)

39. The reaction engine of claim 19, wherein the plasma arcing generator comprises a high voltage DC power supply configured to generate a sufficient direct current potential difference for generating the plasma arc during operation of the reaction engine, the high voltage DC power supply comprising one or more DC induction scavenging units (ISU) arranged on one or more support structures, wherein each DC ISU comprises an ISU coil positioned such that the arrangement of magnets of the corresponding rotor move in proximity past the ISU coil to thereby generate an electromotive force within the ISU coil, and wherein each DC ISU comprises an ISU output circuit for generating an output DC voltage forming at least a portion of the high voltage DC power supply.

40. The reaction engine of claim 26, further comprising a water injection assembly configured to inject water into the airflow.

41. (canceled)
